(19) United States
(12) Patent Application Publication
(10) Pub. No.: US 2025/0314050 A1
(43) Pub. Date: Oct. 9, 2025

(54) Underground Passive Water-Cooling System and Method of Use

(71) Applicant: David Allison, Clifton, TX (US)

(72) Inventor: David Allison, Clifton, TX (US)

(21) Appl. No.: 18/966,188

(22) Filed: Dec. 3, 2024

Related U.S. Application Data
(60) Provisional application No. 63/631,468, filed on Apr. 9, 2024.

(51) Int. Cl. E03B 1/04; F24T 10/00; F24T 50/00

(52) U.S. Cl. CPC E03B 1/042; F24T 10/00; F24T 50/00; E03B 2001/047

(57) ABSTRACT

The present invention is a passive water-cooling system designed to reduce the temperature of water supplied to a home. The system comprises a plurality of interconnected cooling devices, each featuring a hollow, elongated “S”-shaped pipe made of thermally conductive materials, such as stainless steel. The devices are installed underground (i.e., below ground surface level) and connected to the main water supply, forming a sealed, leak-proof reservoir system. As water flows through the system, it is cooled by transferring heat to the surrounding ground. The system may include detachable connections to prevent overcooling in winter and can be integrated with rainwater harvesting systems for enhanced sustainability. The system operates without external energy, providing an energy-efficient solution for delivering cooler water to homes.

### CROSS-REFERENCE TO RELATED APPLICATION

The present application claims priority to, and the benefit of, U.S. Provisional Application No. 63/631,468 which was filed on Apr. 9, 2024 and is incorporated herein by reference in its entirety.

### FIELD OF THE INVENTION

The present invention generally relates to the field of residential water-cooling systems. More specifically, the present invention relates to a passive water-cooling device designed to reduce water temperature by utilizing the naturally cooler temperatures found underground. The system consists of interconnected S-shaped pipes made of thermally conductive materials, such as stainless steel, installed underground (i.e., below ground surface level) and connected to the main water supply. As water flows through these pipes, it is cooled by the surrounding ground before being distributed throughout the home. Accordingly, the present disclosure makes specific reference thereto. Nonetheless, it is to be appreciated that aspects of the present invention are also equally applicable to other like applications, devices, and methods of manufacture.

### BACKGROUND

By way of background, in many regions, particularly during the hot summer months, it is common for the water in the main incoming water supply to become warmer than desired. This often results in users experiencing warm or even hot water when they turn on the cold side of the faucet. This can be particularly uncomfortable and inconvenient, as cold water is typically expected for various uses such as drinking, cooking, and bathing.

Traditionally, the only methods available to cool water to a desired temperature involve active cooling systems. These systems rely on mechanical or electrical components, such as refrigeration units or chillers, to lower the water temperature. However, these methods consume significant amounts of energy, leading to higher utility costs for the user. Moreover, the installation, maintenance, and operation of these systems can be complex and expensive, requiring additional effort and resources. Individuals desire a more efficient and cost-effective solution that can cool water without relying on active energy-consuming systems

Therefore, there exists a long-felt need in the art for a passive water-cooling system that efficiently reduces the temperature of water supplied to homes without relying on energy-intensive methods. There is also a long-felt need in the art for a water-cooling solution that leverages natural processes to lower water temperature. Additionally, there is a long-felt need in the art for a system that can be easily integrated into existing water supply infrastructures without requiring extensive modifications or maintenance. Moreover, there is a long-felt need in the art for a cooling device that can be customized to fit various installation environments and provide effective cooling regardless of external weather conditions. Furthermore, there is a long-felt need in the art for a water-cooling solution that enhances user comfort by delivering consistently cooler water during warm seasons. Finally, there is a long-felt need in the art for a water-cooling system that operates passively, requiring no external power sources, thus offering a sustainable and cost-effective alternative to conventional cooling methods.

The subject matter disclosed and claimed herein, in one embodiment thereof, comprises a passive water-cooling device and system. The device includes a hollow, elongated pipe configured in an “S” shape, with a first end and a second end, each equipped with flanges for securely connecting to similar devices to form a sealed, leak-proof system. The device is made from thermally conductive materials, such as stainless steel, and is designed to be installed underground. As water flows through the pipe, the surrounding cooler ground absorbs heat from the water, thereby reducing its temperature before it is distributed throughout the home. The system includes a plurality of interconnected devices and is customizable to accommodate various installation sites, enabling for optimal cooling performance based on the specific environmental conditions. The device operates without the need for external energy, making it an energy-efficient solution for cooling household water supplies.

In this manner, the passive water-cooling system of the present invention accomplishes all of the foregoing objectives and provides a novel solution for reducing the temperature of water supplied to homes. The system utilizes an interconnected network of S-shaped pipes made from thermally conductive materials, installed underground to take advantage of naturally cooler ground temperatures. As water flows through the system, it loses heat to the surrounding earth, resulting in a significant reduction in temperature before reaching the home's plumbing system. The system's flanged connections ensure a secure and leak-proof assembly, while its passive operation eliminates the need for external energy sources. The innovative approach not only provides cooler water but also reduces energy consumption, lowers operational costs, and enhances the overall comfort and convenience for users during warm weather conditions.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a passive water-cooling device for reducing the temperature of water supplied to a home. The device comprises a hollow, elongated pipe configured in an “S” shape, the pipe has a first end and a second end. A first flange is disposed on the first end and a second flange is disposed on the second end of the pipe, the first flange and second flange being adapted to connect and fasten the passive water-cooling device with other similar devices to form a sealed, leak-proof system. The hollow elongated pipe is configured to hold a predetermined quantity of water and is adapted to be installed underground for cooling the water by transferring heat from the water to the cooler surrounding ground before the water is distributed throughout the home.

In yet another embodiment, a water-cooling system for cooling water supplied to a home is disclosed. The system includes a plurality of interconnected passive water-cooling devices, each device includes a hollow, elongated pipe configured in an “S” shape with a first end and a second end. A first flange is disposed on the first end and a second flange is disposed on the second end of the pipe, the first flange and second flange being adapted to connect and fasten the passive water-cooling device with other similar devices to form a sealed, leak-proof system, wherein the plurality of interconnected passive water-cooling devices are installed underground (i.e., below ground surface level) and connected to the main water supply of the home, thereby forming a reservoir system in which water is cooled by the surrounding ground as it flows through the system before being distributed throughout the home.

In another aspect, the device includes detachable connection at the ends of each passive water-cooling device that enables selective bypassing of the underground system to prevent water from becoming too cold during winter.

In another embodiment, a method for cooling water supplied to a home using a passive water-cooling system is disclosed. The method comprises the steps of installing a plurality of interconnected passive water-cooling devices underground, each device comprises a hollow, elongated pipe configured in an “S” shape, with a first end and a second end, and flanges are disposed at the ends of each pipe for connecting the devices to form a sealed system, connecting the underground passive water-cooling system to the main water supply of the home, enabling water to flow from the main water supply into the passive water-cooling system, cooling the water as it flows through the underground passive water-cooling system by transferring heat from the water to the cooler surrounding ground, and distributing the cooled water from the passive water-cooling system throughout the home.

In still another embodiment, the pipe is coated with a material having superior thermal conductivity, such as graphene, to enhance the rate at which heat is transferred from the water to the surrounding ground.

In yet another aspect, the system is further connected to a rainwater harvesting system, enabling cooled rainwater to be stored and used, reducing reliance on municipal water supplies

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of thermally conductive underground water-cooling apparatus of the present invention for reducing temperature of water in accordance with the disclosed structure;

FIG. 2 illustrates a perspective view of water-cooling underground system formed using a plurality of interconnected passive cooling devices of the present invention in accordance with the disclosed structure;

FIG. 3 illustrates a perspective view showing the water-cooling system installed underground in a home in accordance with one embodiment of the present invention;

FIG. 4 illustrates a flow chart depicting a process of use of the water-cooling system for cooling water in accordance with the disclosed structure; and

FIG. 5 illustrates a perspective view showing the water being cooled using the system in warm temperatures in accordance with the disclosed structure.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a passive water-cooling system that efficiently reduces the temperature of water supplied to homes without relying on energy-intensive methods. There is also a long-felt need in the art for a water-cooling solution that leverages natural processes to lower water temperature. Additionally, there is a long-felt need in the art for a system that can be easily integrated into existing water supply infrastructures without requiring extensive modifications or maintenance. Moreover, there is a long-felt need in the art for a cooling device that can be customized to fit various installation environments and provide effective cooling regardless of external weather conditions. Furthermore, there is a long-felt need in the art for a water-cooling solution that enhances user comfort by delivering consistently cooler water during warm seasons. Finally, there is a long-felt need in the art for a water-cooling system that operates passively, requiring no external power sources, thus offering a sustainable and cost-effective alternative to conventional cooling methods.

The present invention, in one exemplary embodiment, is a water-cooling system for cooling water supplied to a home. The system includes a plurality of interconnected passive water-cooling devices, each device includes a hollow, elongated pipe configured in an “S” shape with a first end and a second end. A first flange is disposed on the first end and a second flange is disposed on the second end of the pipe, the first flange and second flange being adapted to connect and fasten the passive water-cooling device with other similar devices to form a sealed, leak-proof system, wherein the plurality of interconnected passive water-cooling devices are installed underground (i.e., below ground surface level) and connected to the main water supply of the home, thereby forming a reservoir system in which water is cooled by the surrounding ground as it flows through the system before being distributed throughout the home.

Reference will now be made in detail to the present preferred embodiments of the invention, examples of which are illustrated in the accompanying drawings. Wherever possible, the same reference numerals are used in the drawings and the description to refer to the same or like parts.

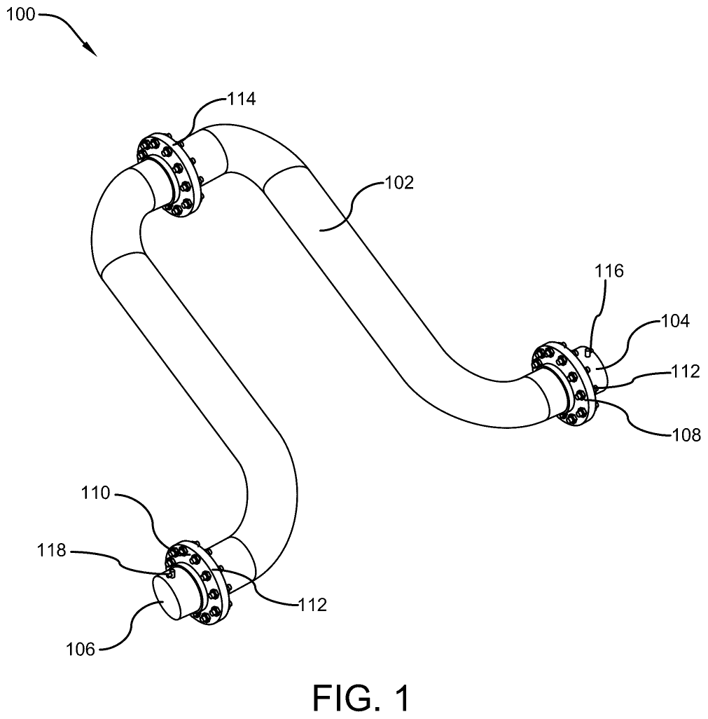

Referring initially to the drawings, FIG. 1 illustrates a perspective view of thermally conductive underground water-cooling apparatus of the present invention for reducing temperature of water in accordance with the disclosed structure. The water-cooling passive device 100 of the present invention is designed to reduce the temperature of the water supplied to a home by using the naturally cooler temperatures found underground. In use, a plurality of interconnected cooling devices 100 are installed underground (i.e., below ground surface level) and connected to the main water supply line of a home. More specifically, the device 100 is configured in an “S” shape and can be made of a durable and thermal conductive material such as stainless steel or any metal. As illustrated, the device 100 includes an elongated pipe 102 in the form of “S” shape and has a pair of opposite ends 104, 106. The pipe 102 is hollow and can be easily installed in a relatively compact space underground.

A first flange 108 is disposed on the first end 104 and a second flange 110 is disposed on the second end 106 of the device 100. The flanges 108, 110 are adapted to connect and fasten the water-cooling passive devices 100 with each other for creating a sealed, leak-proof system. Each flange 108, 110 is preferably circular and includes a plurality of bolts 112 that are used for connecting different pipe devices 100 together securely. An additional flange 114 is also provided for enabling additional support to the device 100 during installation. The S-shaped pipe 102 is adapted to hold a predetermined quantity of water such as at least 25 gallons for providing cooling without requiring a large amount of horizontal or vertical space. In use, as water flows slowly through the device 100, the water loses heat to the cooler ground, thus lowering the temperature before the water is distributed throughout the home. The size and shape of the cooling device 100 can be customized depending on the specific installation site and the desired cooling effect.

The ends 104, 106 of the S-pipe 102 also includes corresponding connection points 116, 118 for connection to the main water supply and the rest of the home's plumbing system. The connection points 116, 118 can also be selectively used for opening and closing the flow of water in the device 100.

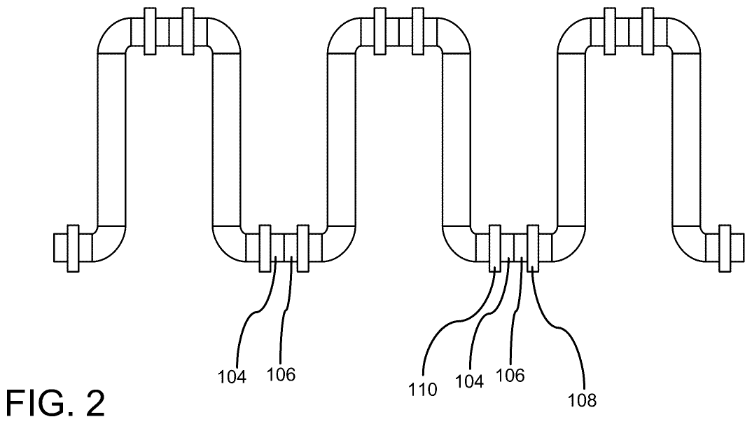

FIG. 2 illustrates a perspective view of water-cooling underground system formed using a plurality of interconnected passive cooling devices of the present invention in accordance with the disclosed structure. The water-cooling system 200 includes a plurality of passive cooling devices 100 of FIG. 1 interconnected with each other. Preferably, the ends 104, 106 of a device 100 are connected to adjacent similar devices and are fastened using the flanges 108, 110 for creating a leak proof system. The number and orientation of the devices 100 can be designed based on the area to be covered and distance from the inlet supply of the water to the house's plumbing system. Each S-pipe can hold a certain volume of water and as water flows slowly through the extended pipe system 200, the water loses heat to the cooler ground, thus lowering the temperature thereof before the water is distributed throughout the home.

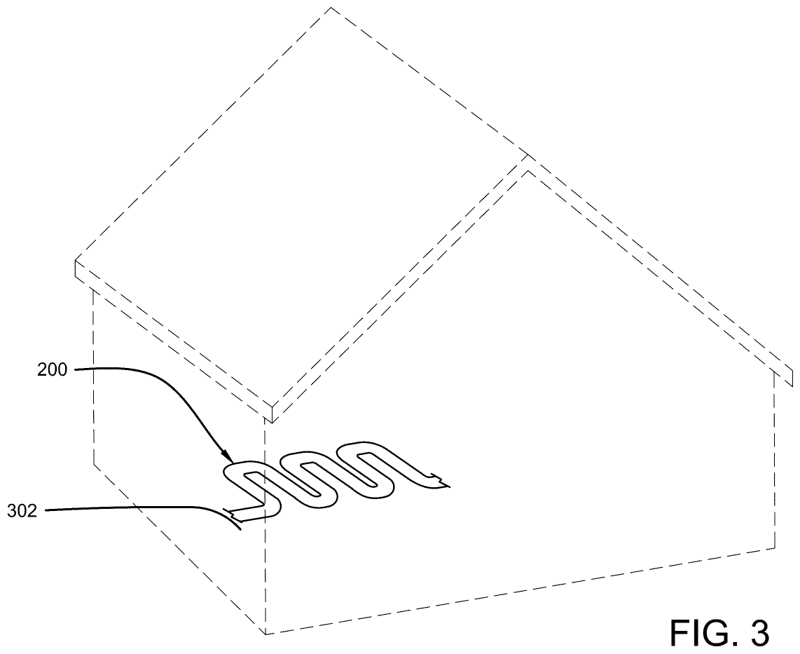

FIG. 3 illustrates a perspective view showing the water-cooling system 200 installed underground in a home in accordance with one embodiment of the present invention. As illustrated, the system 200 including a plurality of interconnected cooling devices 100 is installed underground (i.e., below ground surface level) and the cooling effect occurs as water travels through the pipes, where the surrounding ground naturally cools the water. The system 200 uses no external energy source and relies entirely on the natural cooling effect of the ground, making the system 200 an energy-efficient solution. The system 200 provides cooler water to taps, showers, and appliances, enhancing comfort and reducing the need for additional cooling systems. The system 200 functions as a reservoir system and the plurality of devices 100 together create a large volume where water is stored and cool down. The reservoir system 200 is buried underground 302, where the temperature is naturally lower than the air temperature above ground.

In some embodiments of the present invention, the pipe 102 can be coated with graphene or similar materials that have superior thermal conductivity, enhancing the rate at which heat is transferred from the water to the surrounding ground. In one embodiment, the system 100 is detachable from the input supply, thereby bypassing the underground pipes to prevent water from becoming too cold in winter season.

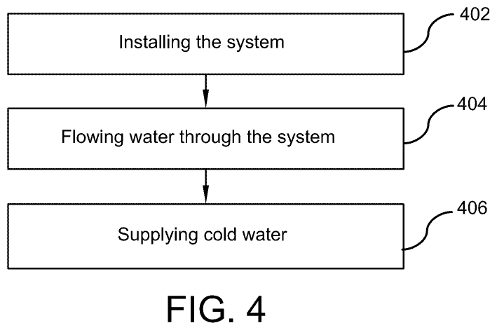

FIG. 4 illustrates a flow chart depicting a process of use of the water-cooling system for cooling water in accordance with the disclosed structure. Initially, the system 200 is installed underground (i.e., below ground surface level) and is connected to the main water supply of the building (Step 402). Then, as water flows out of the main supply, the water flows into the underground S-pipe reservoir system 200 and comes into contact with the cool walls of the stainless-steel pipes of individual devices (Step 404). The temperature of the ground surrounding the pipes is lower than the temperature of the water. The ground effectively acts as a natural heat sink, absorbing heat from the water through the pipe walls. After the water has been sufficiently cooled in the underground reservoir, the water continues through the rest of the home's plumbing system, where it can be used for drinking, bathing, and other household purposes (Step 406).

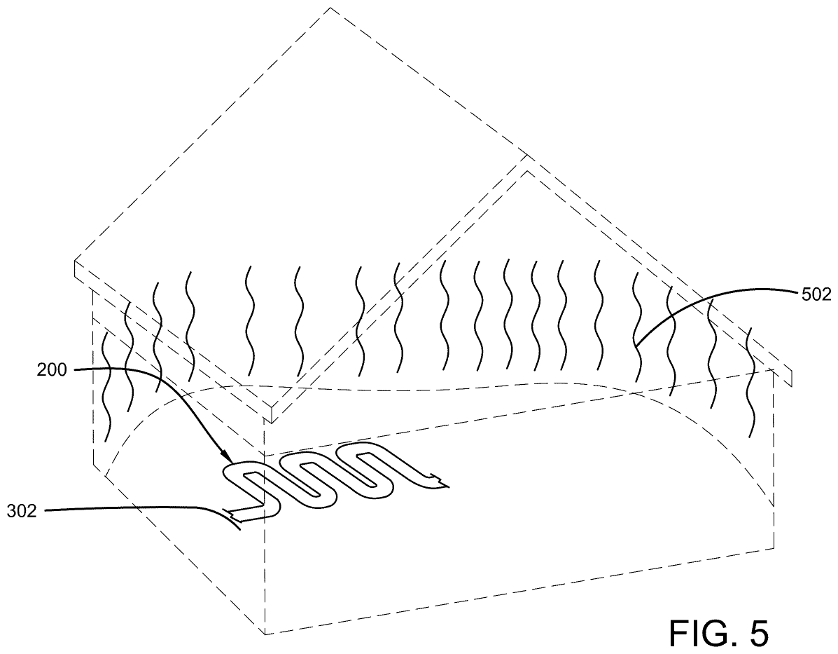

FIG. 5 illustrates a perspective view showing the water being cooled using the system 200 in warm temperatures in accordance with the disclosed structure. The water passing through the system 200 is maintained at a lower temperature in comparison to the ambient warm temperature 502. In one embodiment, the system 200 can be connected to a rainwater harvesting system enabling rainwater to be cooled and stored for later use, reducing reliance on municipal water supplies and enhancing sustainability.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “thermally conductive underground water-cooling apparatus”, “water-cooling passive device”, “cooling device”, and “device” are interchangeable and refer to the thermally conductive underground water-cooling apparatus 100 of the present invention. Similarly, as used herein “water-cooling underground system”, “water-cooling system”, “system”, and “underground passive water-cooling system” are interchangeable and refer to the underground passive water-cooling system 200 of the present invention

Notwithstanding the forgoing, the thermally conductive underground water-cooling apparatus 100 and the underground passive water-cooling system 200 of the present invention can be of any suitable size and configuration as is known in the art without affecting the overall concept of the invention, provided that it accomplishes the above stated objectives. One of ordinary skill in the art will appreciate that the thermally conductive underground water-cooling apparatus 100 and the underground passive water-cooling system 200 as shown in the FIGS. are for illustrative purposes only, and that many other sizes and shapes of the thermally conductive underground water-cooling apparatus 100 and the underground passive water-cooling system 200 are well within the scope of the present disclosure. Although the dimensions of the thermally conductive underground water-cooling apparatus 100 and the underground passive water-cooling system 200 are important design parameters for user convenience, the thermally conductive underground water-cooling apparatus 100 and the underground passive water-cooling system 200 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A water-cooling device for passively changing a temperature of water comprising:
an elongated pipe having a first end and an opposing second end; and
a water supply line;
wherein said elongated pipe is hollow;
wherein said elongated pipe installed underground;
wherein said first end connected to said water supply line;
wherein said second end connected to a home's plumbing system; and
further wherein water is passed from said water supply line through said elongated pipe for reducing a temperature of the water supplied to said home's plumbing system.

2. The water-cooling device for passively changing a temperature of water of claim 1, wherein said elongated pipe having an “S” shape.

3. The water-cooling device for passively changing a temperature of water of claim 2, wherein said elongated pipe is a plurality of elongated pipes.

4. The water-cooling device for passively changing a temperature of water of claim 3, wherein said plurality of elongated pipes having a thermal conductive material of stainless steel.

5. The water-cooling device for passively changing a temperature of water of claim 4, wherein a first flange disposed on a first end of a first elongated pipe and a second flange disposed on a second end of a second elongated pipe, and further wherein said first flange fastened to said second flange.

6. The water-cooling device for passively changing a temperature of water of claim 5, wherein said water supply line is a rainwater harvesting supply line.

7. The water-cooling device for passively changing a temperature of water of claim 6, wherein a third flange disposed on an intermediate portion of at least one of said plurality of elongated pipes for supporting said at least one of said plurality of elongated pipes.

8. The water-cooling device for passively changing a temperature of water of claim 7, wherein said plurality of elongated pipes having a quantity of water stored within said plurality of elongated pipes of at least 25 gallons.

9. A water-cooling device for passively changing a temperature of water comprising:
an elongated pipe having a first end and an opposing second end; and
a water supply line;
wherein said elongated pipe is hollow;
wherein said elongated pipe installed underground;
wherein said elongated pipe is a plurality of elongated pipes;
wherein said first end connected to said water supply line;
wherein said opposing second end connected to a home's plumbing system;
wherein water is passed from said water supply line through said plurality of elongated pipes for reducing a temperature of the water supplied to said home's plumbing system; and
further wherein said plurality of elongated pipes having a quantity of water stored within said plurality of elongated pipes of at least 25 gallons.

10. The water-cooling device for passively changing a temperature of water of claim 9, wherein each of said plurality of elongated pipes having an “S” shape.

11. The water-cooling device for passively changing a temperature of water of claim 10, wherein said plurality of elongated pipes having a thermal conductive material of stainless steel.

12. The water-cooling device for passively changing a temperature of water of claim 11, wherein a first flange disposed on a first end of a first elongated pipe and a second flange disposed on a second end of a second elongated pipe, and further wherein said first flange fastened to said second flange.

13. The water-cooling device for passively changing a temperature of water of claim 12, wherein said water supply line is a rainwater harvesting supply line.

14. The water-cooling device for passively changing a temperature of water of claim 13, wherein a third flange disposed on an intermediate portion of at least one of said plurality of elongated pipes for supporting said at least one of said plurality of elongated pipes.

15. A water-cooling device for passively changing a temperature of water comprising:
a plurality of interconnected elongated pipes having a first terminal end and an opposing second terminal end; and
a water supply line;
wherein said plurality of elongated pipes are hollow;
wherein said plurality of elongated pipes installed underground;
wherein said first terminal end connected to said water supply line;
wherein said opposing second terminal end connected to a home's plumbing system;
wherein water is passed from said water supply line through said plurality of elongated pipes for reducing a temperature of the water supplied to said home's plumbing system; and
further wherein said plurality of elongated pipes having a quantity of water stored within said plurality of elongated pipes of at least 25 gallons.

16. The water-cooling device for passively changing a temperature of water of claim 15, wherein each of said plurality of elongated pipes having an “S” shape.

17. The water-cooling device for passively changing a temperature of water of claim 16, wherein said plurality of elongated pipes having a thermal conductive material of stainless steel.

18. The water-cooling device for passively changing a temperature of water of claim 17, wherein a first flange disposed on a first end of a first elongated pipe and a second flange disposed on a second end of a second elongated pipe, and further wherein said first flange fastened to said second flange.

19. The water-cooling device for passively changing a temperature of water of claim 18, wherein said water supply line is a rainwater harvesting supply line.

20. The water-cooling device for passively changing a temperature of water of claim 19, wherein a third flange disposed on an intermediate portion of at least one of said plurality of elongated pipes for supporting said at least one of said plurality of elongated pipes.
